(19) United States
(12) Patent Application Publication
(10) Pub. No.: US 2011/0189506 A1
(43) Pub. Date: Aug. 4, 2011

(54) GLASS SUBSTRATE FOR MAGNETIC RECORDING MEDIUM, AND METHOD FOR MANUFACTURING THE SAME

(75) Inventors: Kazuo Mannami, Ayuttahaya (TH); Hitoshi Mishiro, Ayuttahaya (TH); Norihito Shida, Ayuttahaya (TH); Masabumi Ito, Ayuttahaya (TH); Hiroyuki Masuda, Chiba (JP); Toru Momose, Tokyo (JP)

(73) Assignee: Asahi Glass Company, Limited, Chiyoda-ku (JP)

(21) Appl. No.: 13/017,609

(22) Filed: Jan. 31, 2011

(30) Foreign Application Priority Data
Feb. 1, 2010 (JP) 2010-020520

(51) Int. Cl. G11B 5/82; B24B 1/00; G11B 5/73

(52) U.S. Cl. 428/846.9; 451/41

(57) ABSTRACT

The present invention relates to a glass substrate for a magnetic recording medium, which is a disk-shaped glass substrate for a magnetic recording medium having a circular hole at the center thereof, in which the glass substrate for a magnetic recording medium has an inner peripheral side surface, an outer peripheral side surface and both main surfaces, and the both main surfaces have parallelism of 3.2 μm or less in at least a recording and reproducing region thereof.

### FIELD OF THE INVENTION

The present invention relates to a glass substrate for a magnetic recording medium, having excellent parallelism, and a method for manufacturing the glass substrate.

### BACKGROUND OF THE INVENTION

With increasing high recording density of a magnetic disk in recent years, characteristics required to a glass substrate for a magnetic recording medium are becoming more severe year after year. To achieve high recording density of a magnetic disk, a magnetic head is attempted to pass up to the end of a glass substrate in order to effectively utilize an area of a main surface of the glass substrate. Furthermore, investigations are made to increase rotation speed of a magnetic disk in order to rapidly record a large volume of information in a magnetic disk and reproducing the information.

In the cases of passing a magnetic head up to the end of a glass substrate or in the case of increasing rotation speed of a magnetic disk, if a glass substrate for a magnetic recording medium has turbulence in shape (such as thickness distribution, end shape, flatness and the like), floating posture of the magnetic heat is disturbed, and there is a possibility that the magnetic head contacts a magnetic recording medium, thereby causing a fault due to the contact.

As a technique of controlling a shape, particularly, a thickness, of a glass substrate for a magnetic recording medium, a glass substrate having a thickness distribution in the same glass substrate plane of a glass substrate for a magnetic recording medium controlled to a given shape (Patent Document 1) and a carrier for reducing thickness variation of each substrate for a magnetic recording medium polished in the same lot (Patent Document 2) are proposed.

However, the thickness distribution (hereinafter referred to as “parallelism”) of the glass substrate for a magnetic recording medium described in Patent Document 1 has a shape that the main surface inclines such that a thickness of a glass substrate is decreased toward an outer surface from the central part, and the purpose of the shape is to prevent breakage of a glass substrate by an outer shock. Patent Document 1 does not contain any disclosure or suggestion of stabilizing floating posture of a magnetic head, thereby performing recording and reproducing to a magnetic disk by a magnetic head with high accuracy. Furthermore, Patent Document 1 does not make investigations in the relationship between parallelism and polishing of a glass substrate for a magnetic recording medium.

The carrier described in Patent Document 2 is effective to only polishing using a soft pad. By designing a holding part of a glass substrate and a gear part into different material and thickness, the glass substrate is suppressed from being sunk in a soft pad, so that polishing load applied to a glass substrate does not become heterogeneous, thereby controlling a removal volume of a glass substrate and reducing thickness variation of each substrate in the same lot. However, Patent Document 2 does not improve parallelism among polished glass substrates for a magnetic recording medium.
Patent Document 1: JP-A-2006-318583
Patent Document 2: JP-A-2009-214219

### SUMMARY OF THE INVENTION

The present invention has an object to provide a glass substrate for a magnetic recording medium, having excellent parallelism. The present invention further has objects to provide a polishing method of a glass substrate, comprising polishing a glass substrate for a magnetic recording medium, having excellent parallelism in high productivity, and a method for manufacturing a glass substrate for a magnetic recording medium, including the polishing method.

The present invention provides a glass substrate for a magnetic recording medium, which is a disk-shaped glass substrate for a magnetic recording medium having a circular hole at the center thereof, wherein the glass substrate for a magnetic recording medium has an inner peripheral side surface, an outer peripheral side surface and both main surfaces, and the both main surfaces have parallelism of 3.2 μm or less in at least a recording and reproducing region thereof.

Additionally, the present invention provides a method for manufacturing a glass substrate for a magnetic recording medium, the method comprising a shape-forming step of performing shape forming to a glass substrate having a sheet shape; a lapping step of lapping a main surface of the glass substrate; a polishing step of polishing the main surface; and a cleaning step of cleaning the glass substrate, wherein the polishing step comprises: interposing a carrier holding the glass substrate having a sheet shape between a polishing surface of an upper platen of a double side polishing machine and a polishing surface of a lower platen thereof; and polishing both main surfaces of the glass substrate simultaneously by relatively moving the glass substrate and the polishing surfaces, while supplying a polishing slurry to the both main surfaces of the glass substrate in the state that the polishing surface of the upper platen and the polishing surface of the lower platen are pressed to the both main surfaces of the glass substrate, respectively, the upper platen and the lower platen have a disk shape having an inner peripheral edge and an outer peripheral edge, and shapes of the polishing surface of the upper platen and the polishing surface of the lower platen, of the double side polishing machine before polishing the glass substrate are shapes so that when a distance between the polishing surface of the upper platen and the polishing surface of the lower platen, at the inner peripheral edge is Din and a distance between the polishing surface of the upper platen and the polishing surface of the lower platen, at the outer peripheral edge is Dout, ΔD (=Dout−Din) obtained by subtracting Din from Dout is from −30 μm to +30 μm.

According to the method for manufacturing a glass substrate for a magnetic recording medium, including a polishing step using the polishing method of the present invention, a glass substrate for a magnetic recording medium, having excellent uniformity of a thickness can be produced in high productivity. A magnetic disk is produced by forming a thin film such as a magnetic layer and others on the glass substrate for a magnetic recording medium, having excellent parallelism of the present invention, and the magnetic disk can eliminate or reduce a fault generated by contacting a magnetic head with a magnetic disk in HDD (Hard Disk Drive) test.

### BRIEF DESCRIPTION OF THE DRAWINGS

FIG. 1 is a perspective view of a glass substrate for a magnetic recording medium.

FIG. 2 is a cross-sectional perspective view of a glass substrate for a magnetic recording medium.

FIGS. 3A to 3D are examples that parallelism of a glass substrate for a magnetic recording medium was measured with a laser interferometer, wherein FIG. 3A is the relationship between the number of interference fringes observed with a laser interferometer and parallelism of a glass substrate for a magnetic recording medium, and FIGS. 3B to 3D are images of interference fringes observed with a laser interferometer (images that the number of interference fringes is 1, 7 and 12).

FIG. 4 is a schematic view of a double side polishing machine.

FIG. 5 is a schematic view showing shape measurement positions on a polishing surface of an upper platen and a polishing surface of a lower platen.

FIG. 6 is a cross-sectional view schematically showing a shape when shapes of a polishing surface of an upper platen and a polishing surface of a lower platen, of a double side polishing machine before polishing a glass substrate satisfy ΔD(=Dout−Din)>0.

FIG. 7 is a cross-sectional view schematically showing a shape when shapes of a polishing surface of an upper platen and a polishing surface of a lower platen, of a double side polishing machine before polishing a glass substrate satisfy ΔD(=Dout−Din)<0.

FIGS. 8A to 8E are measurement results (Examples 1 to 5) of shapes of a polishing surface of an upper platen and a polishing surface of a lower platen.

FIGS. 9A to 9D are measurement results (Examples 6 to 9) of shape of a polishing surface of an upper platen and a polishing surface of a lower platen.

FIG. 10 is a graph showing the relationship between difference (ΔTsd) between a polishing slurry temperature and a dressing liquid temperature, and parallelism of a glass substrate.

FIG. 11 is a graph showing the relationship between nano waviness Wq and parallelism, of a glass substrate for a magnetic recoding medium.

### DETAILED DESCRIPTION OF THE INVENTION

The present invention is described below by reference to the mode for carrying out the invention, but it should be understood that the invention is not construed as being limited to the following embodiments.

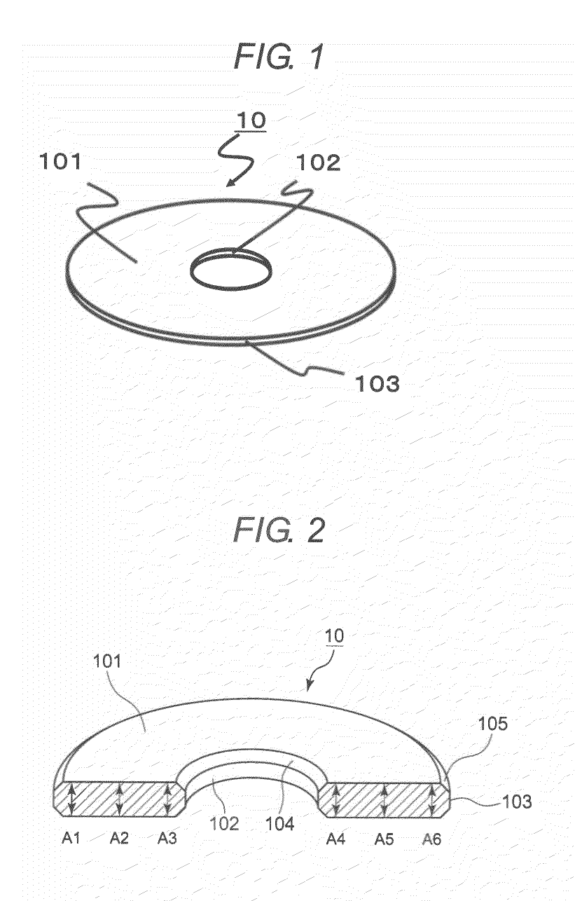

A perspective view of a glass substrate 10 for a magnetic recording medium of the present invention is shown in FIG. 1, and a cross-sectional perspective view of the cut glass substrate 10 for a magnetic recording medium is shown in FIG. 2. In FIGS. 1 and 2, 101 shows a main surface of a glass substrate for a magnetic recoding medium, 102 shows an inner peripheral side surface thereof, 103 shows an outer peripheral side surface thereof, 104 shows an inner peripheral chamfered part thereof and 105 shows an outer peripheral chamfered part thereof. In FIG. 2, A1 and A6 show a thickness of an outer diameter side region of a glass substrate for a magnetic recoding medium, A2 and A5 show a thickness of an intermediate region of a glass substrate for a magnetic recoding medium, and A3 and A4 show a thickness of an inner diameter side region of a glass substrate for a magnetic recoding medium.

The parallelism of both main surfaces of the glass substrate for a magnetic recording medium is excellent when a thickness (for example, A1 to A6) in each region of the glass substrate for a recording medium is uniform, and is poor when a thickness in each region is heterogeneous (thickness variation is large).

The parallelism of both main surfaces of the glass substrate for a magnetic recording medium can be measured with a measuring instrument such as a micrometer, a laser displacement meter or a laser interferometer. Of those measuring instruments, a laser interferometer uses light wavelength as a measure, and can measure the parallelism with high precision. Furthermore, the laser interferometer can measure the parallelism of both main surfaces of a glass substrate for a magnetic recording medium by one measurement for obtaining data, and therefore has excellent measurement efficiency. For this reason, the laser interferometer is preferably used as a parallelism measuring instrument of a glass substrate for a magnetic recording medium.

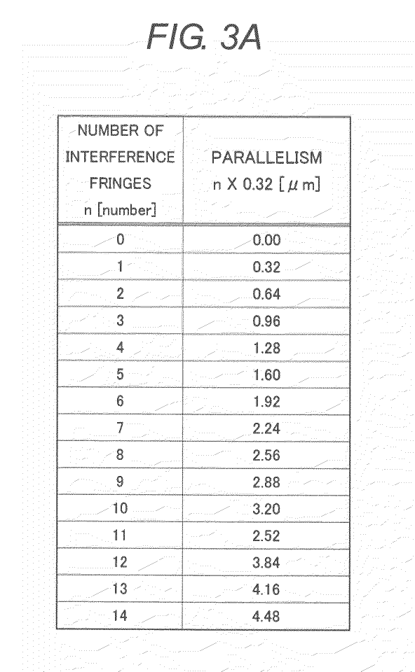

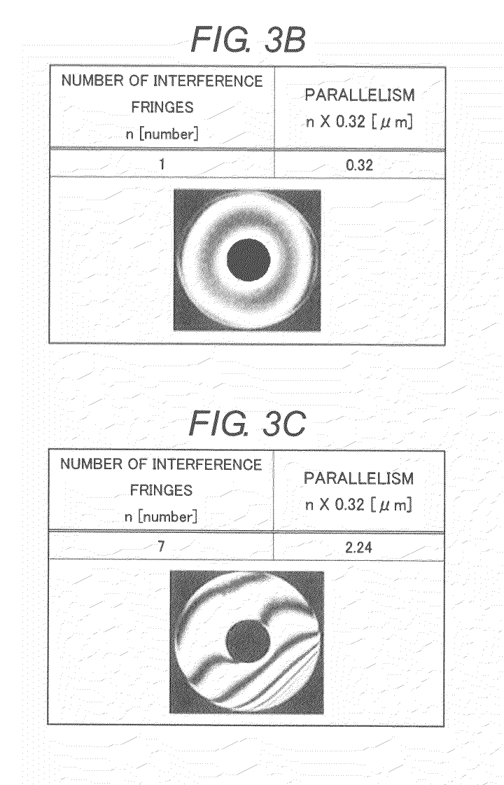

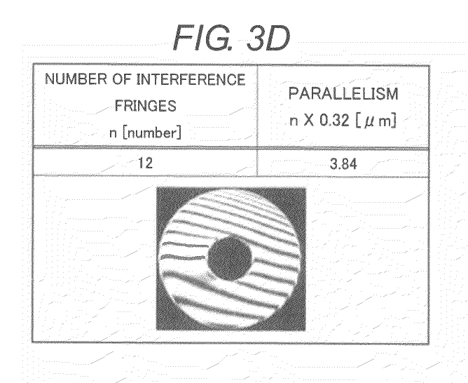

An example that the parallelism of both main surfaces of a glass substrate for a magnetic recording medium was measured with a laser interferometer (a product name: plane measuring Fizeau interferometer G102, manufactured by Fujinon Co., Ltd.) used in the Examples of the present invention is shown in FIGS. 3A to 3D. The parallelism of both main surfaces of a glass substrate for a magnetic recording medium is measured by observing interference fringes formed by retardation of reflected light reflected from the both main surfaces and analyzing the interference patters obtained. Light and dark interference fringes observed with a laser interferometer show contour lines, and its interval is determined by a wavelength of light source and an incident angle thereof.

The relationship between the number of interference fringe observed with a laser interferometer used in the Examples of the present invention and parallelism of a glass substrate for a magnetic recording medium is shown in FIG. 3A, and images observed with a laser interferometer (images that the number of interference fringe is 1, 7 and 12) is shown in FIGS. 3B to 3D. The parallelism of both main surfaces of a glass substrate for a magnetic recording medium is excellent with decreasing the number of interference fringes observed. In other words, small number of the interference fringes means that a thickness of the region on which the parallelism of both main surfaces of a glass substrate for a magnetic recording medium was measured is uniform, and a thickness distribution in a glass substrate surface is excellent.

When the number of the interference fringe observed is one, the parallelism of both main surfaces of the glass substrate for a magnetic recording medium is 0.32 μm, and a thickness distribution of the region on which the parallelism of the glass substrate for a magnetic recording medium was measured is formed with 0.32 μm or less. The number of the interference fringes of the glass substrate for a magnetic recording medium, having the parallelism of 3.2 μm or less is 10 or less.

HDD (Hard Disk Drive) test results of magnetic disks produced by forming a thin film such as a magnetic layer on the glass substrate for a magnetic recording medium are shown in Table 1. When nano waviness Wq in the outer diameter side region exceeds 0.52 nm, floating posture of a magnetic head is disturbed, and the magnetic head contacts the magnetic recording medium, thereby generating a fault. The floating posture of the magnetic head is stabilized as the value of nano waviness Wq in the outer diameter side region is decreased.

In the present invention, the nano waviness Wq is a nano waviness having a period between 400 μm and 5,000 μm, measured with a light scattering surface profiler. The nano waviness Wq is measured by entering laser light having a wavelength of 405 nm in the surface of an article to be measured at an angle of 60°, detecting reflected light from the article to be measured, and obtaining information of height of the main surface. The measurement region is 1.0 mm width, and the measurement is conducted in a region of one revolution in a circumferential direction. The position in the circumferential direction of the measurement region (position from the center of the glass substrate for a magnetic recording medium) can optionally be selected.

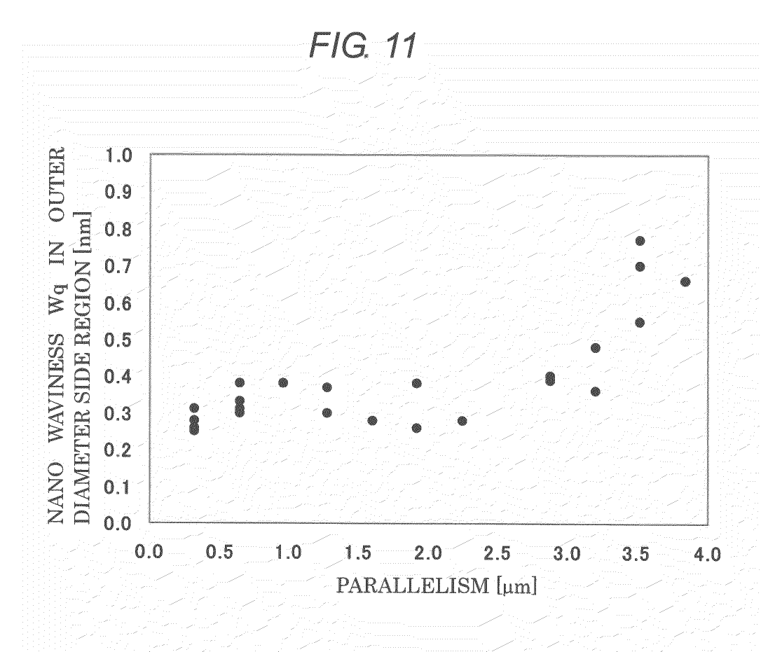

The present inventors have found that there is the correlation between the parallelism of both main surfaces of the glass substrate for a magnetic recording medium and the nano waviness Wq in the outer diameter side thereof. The results of examining the relationship between the parallelism and the nano waviness Wq, of the glass substrate for a magnetic recording medium are shown in FIG. 11. To obtain the glass substrate for a magnetic recording medium, having the nano waviness Wq of 0.52 nm or less on the outer diameter side region, the parallelism of both main surfaces of the glass substrate for a magnetic recording medium is 3.2 μm or less. The parallelism of both main surfaces of the glass substrate for a magnetic recording medium is preferably 3.0 μm or less, more preferably 2.8 μm or less, and particularly preferably 2.5 μm or less.

The manufacturing steps of a glass substrate fdr a magnetic recording medium and a magnetic disk generally include the following steps. (1) A glass sheet molded by a float process or a press molding process is processed into a click shape, and an inner peripheral side surface and an outer peripheral side surface are subjected to chamfering, thereby obtaining a glass substrate. (2) Upper and lower main surfaces of the glass substrate are subjected to lapping. (3) The side surface part and the chamfered part of the glass substrate are subjected to edge polishing. (4) Upper and lower main surfaces of the glass substrate are subjected to polishing. The polishing step may be only primary polishing, may conduct the primary polishing and secondary polishing, and may conduct third polishing after the second polishing. (5) The glass substrate is subjected to precise cleaning, thereby manufacturing a glass substrate for a magnetic recording medium. (6) A thin film such as a magnetic layer is formed on the glass substrate for a magnetic recording medium, thereby manufacturing a magnetic disk.

In the above manufacturing steps of the glass substrate for a magnetic recording medium and the magnetic disk, glass substrate cleaning (in-process cleaning) and etching of a glass substrate surface (in-process etching) may be conducted between the respective steps. Furthermore, when a glass substrate for a magnetic recording medium is required to have high mechanical strength, a strengthening step (for example, chemical strengthening step) of forming a strengthening layer on the surface layer of the glass substrate may be conducted before the polishing step, after the polishing step or between the polishing steps.

In the present invention, the glass substrate for a magnetic recording medium may be an amorphous glass, a crystallized glass or a strengthened glass having a strengthening layer on the surface layer of the glass substrate (for example, a chemically strengthened glass). Furthermore, the glass sheet for the glass substrate of the present invention may be prepared by a float process or a press molding process.

The present invention relates to the step (4) of conducting polishing on upper and lower main surfaces of a glass substrate, and relates to polishing of a glass substrate for a magnetic recording medium.

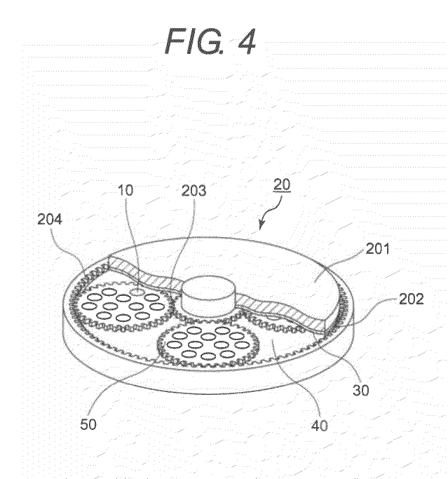

FIG. 4 is a schematic view of a double side polishing machine 20. In FIG. 4, 10 shows a glass substrate for a magnetic recording medium, 30 shows a polishing surface of an upper platen, 40 is a polishing surface of a lower platen, 50 shows a carrier, 201 shows an upper platen, 202 shows a lower platen, 203 shows a sun gear, and 204 shows an internal gear.

The glass substrate 10 for a magnetic recording medium is sandwiched between the polishing surface 30 of the upper platen and the polishing surface 40 of the lower platen in the state that the glass substrate is held on a glass substrate holding part of the carrier 50, a polishing slurry is supplied to both main surfaces of the glass substrate in the state that the polishing surface 30 of the upper platen and the polishing surface 40 of the lower platen are pressed to the both main surfaces of the glass substrate, respectively, and the glass substrate and the polishing surfaces are relatively moved, thereby simultaneously polishing the both main surfaces of the glass substrate.

The double side polishing machine 20 rotation-drives the sun gear 203 and the internal gear 204 at a given rotation ratio, respectively, thereby moving (planet-driving) those so as to orbit the sun gear 203 while rotating the carrier 50, and at the same time, rotation-drives the upper platen 201 and the lower platen 202 in a given rotation number, respectively, thereby polishing the glass substrate.

Polishing pads are provided on faces of the upper platen 201 and the lower platen 202, facing the glass substrate. Dressing treatment is applied to the polishing pads provided on the upper platen 201 and the lower platen 202 using a dressing jig in order to make the polishing surface 30 of the upper platen and the polishing surface 40 of the lower platen have a given shape, respectively. The dressing treatment is conducted by supplying dressing liquid between the dressing jig and the polishing pad, relatively moving the dressing jig and the polishing pads, and lapping the surfaces (faces becoming the polishing surface 30 of the upper platen and the polishing surface 40 of the lower platen) of the polishing pads.

The shape of the surface of the polishing pad having been subjected to the dressing treatment, that is, the polishing surface 30 of the upper platen and the polishing surface 40 of the lower platen, is measured with a straightness measuring device, a dial gauge, a straight gauge, a feeler gauge or the like. Measurement of the shape of the polishing surface with a straightness measuring device can be performed in the state that the upper platen 201 and the lower platen 202 are attached to the double-sided polishing device.

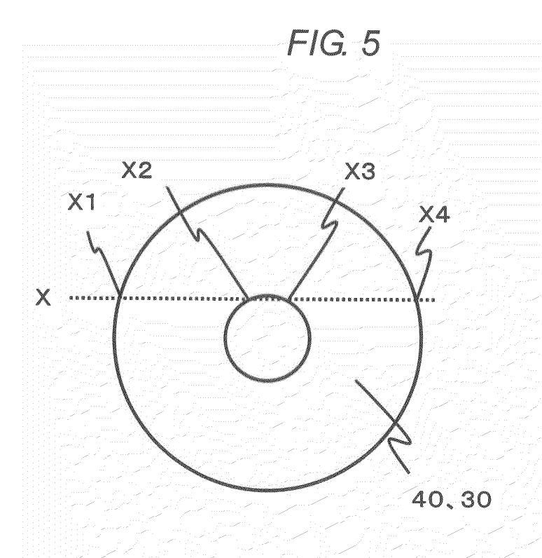

The shape measurement positions of the polishing surface 30 of the upper platen and the polishing surface 40 of the lower platen are shown in FIG. 5. The shape measurement is conducted by scanning such that a gauge head of the straightness measuring device passes inner peripheral edges (X2 and X3) and outer peripheral edges (X1 and X4) of the polishing surfaces 30 and 40.

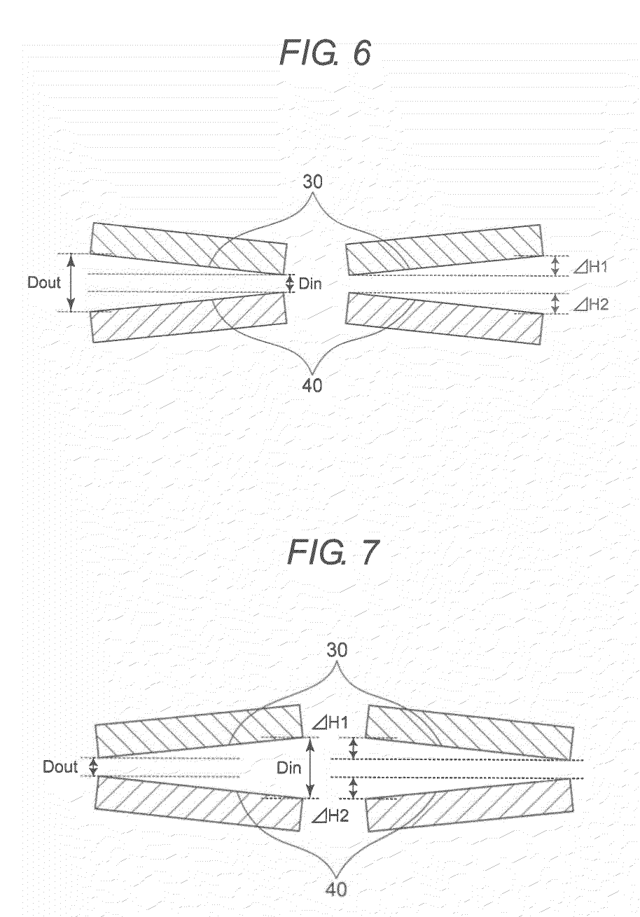

The schematically cross-sectional views of the shapes of the polishing surface 30 of the upper platen and the polishing surface 40 of the lower platen before polishing the glass substrate are shown in FIGS. 6 and 7. In FIGS. 6 and 7, Din shows a distance between the polishing surface 30 of the upper platen and the polishing surface 40 of the lower platen at the inner peripheral edge, Dout shows a distance between the polishing surface 30 of the upper platen and the polishing surface 40 of the lower platen at the outer peripheral edge, ΔH1 shows the maximum difference in height of the polishing surface 30 of the upper platen, and ΔH2 shows the maximum difference in height of the polishing surface 40 of the lower platen. When the inner peripheral edges (X2 and X3) are higher than the outer peripheral edges (X1 and X4), the maximum difference ΔH in height is shown by a plus value, and when the inner peripheral edges (X2 and X3) are lower than the outer peripheral edges (X1 and X4), the maximum difference ΔH in height is shown by a minus value.

When a distance between the polishing surface 30 of the upper platen and the polishing surface 40 of the lower platen at the inner peripheral edge is Din and a distance between the polishing surface 30 of the upper platen and the polishing surface 40 of the lower platen at the outer peripheral edge is Dout, ΔD(=Dout−Din) obtained by subtracting Din from Dout is obtained by subtracting the maximum difference ΔH1 in height of the polishing surface 30 of the upper platen from the maximum difference ΔH2 in height of the polishing surface 40 of the lower platen, and this leads to ΔD=Dout−Din=ΔH2−ΔH1.

FIG. 6 is a cross-sectional view schematically showing the shape of the polishing surface having ΔD(=Dout−Din)>0, and is a shape of the polishing surface in an inner contact state that the polishing surface 30 of the upper platen and the polishing surface 40 of the lower platen strongly contact to each other at the inner peripheral edge side. FIG. 7 is a cross-sectional view schematically showing the shape of the polishing surface having ΔD(=Dout−Din)<0, and is a shape of the polishing surface in an outer contact state that the polishing surface 30 of the upper platen and the polishing surface 40 of the lower platen strongly contact to each other at the outer peripheral edge side.

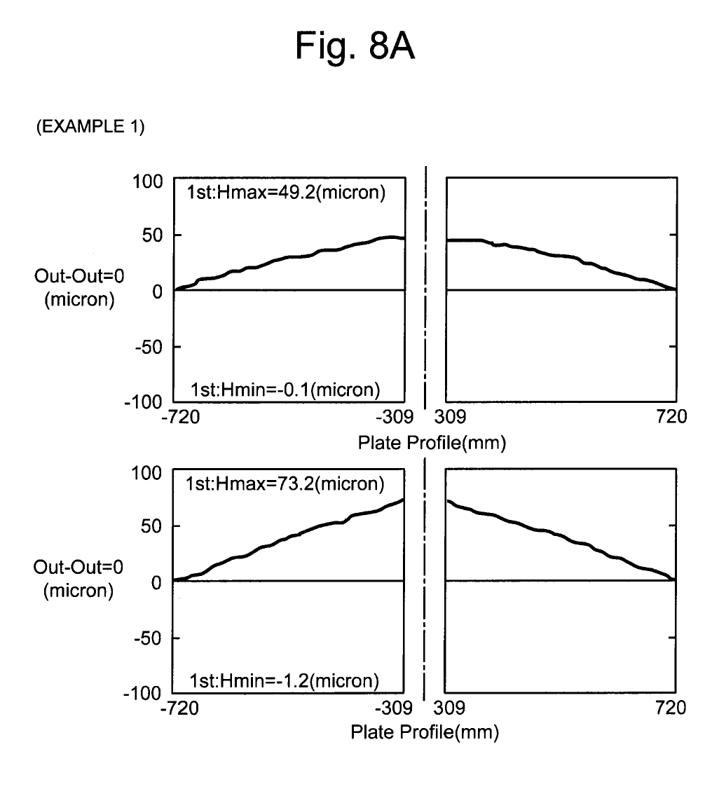

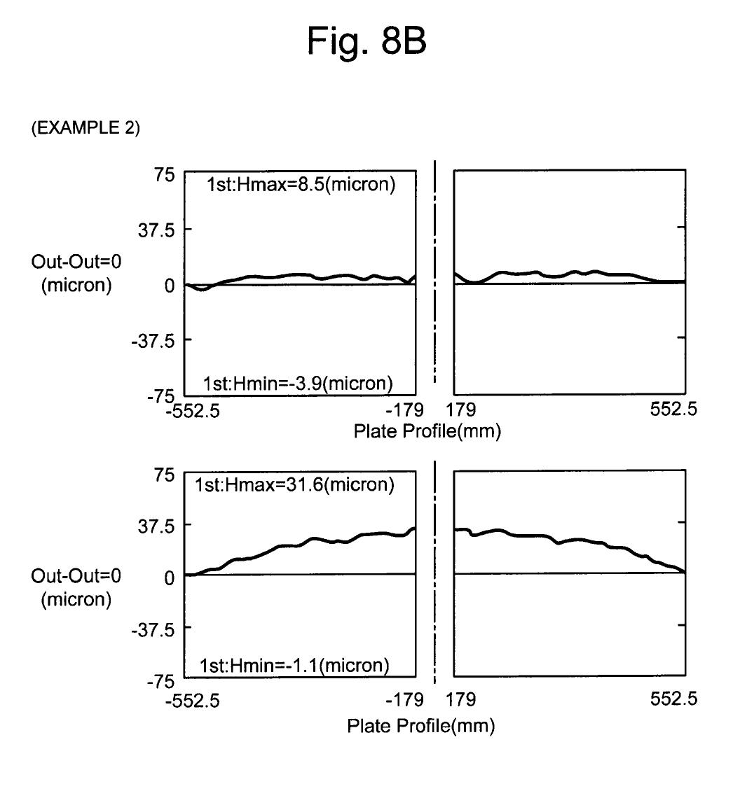

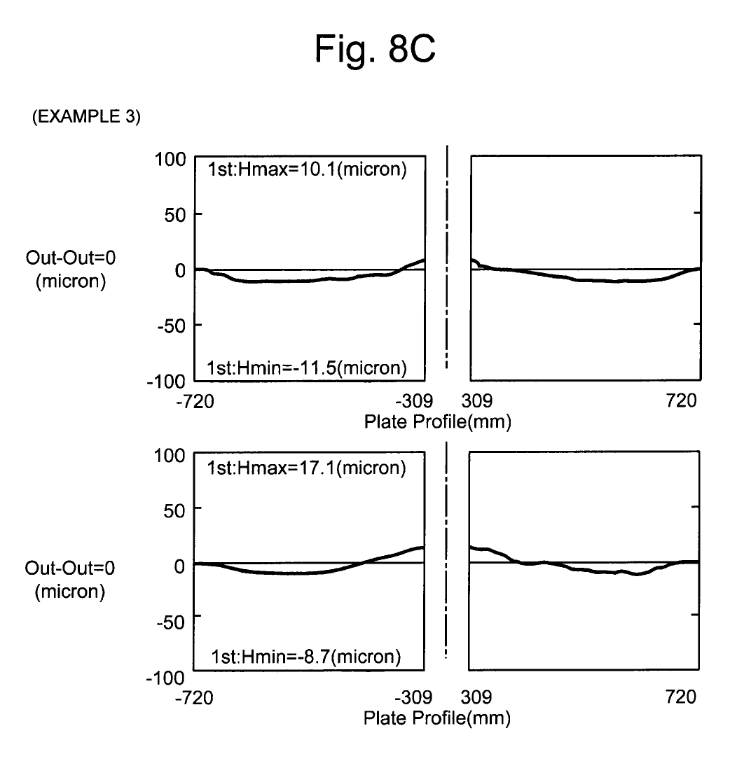

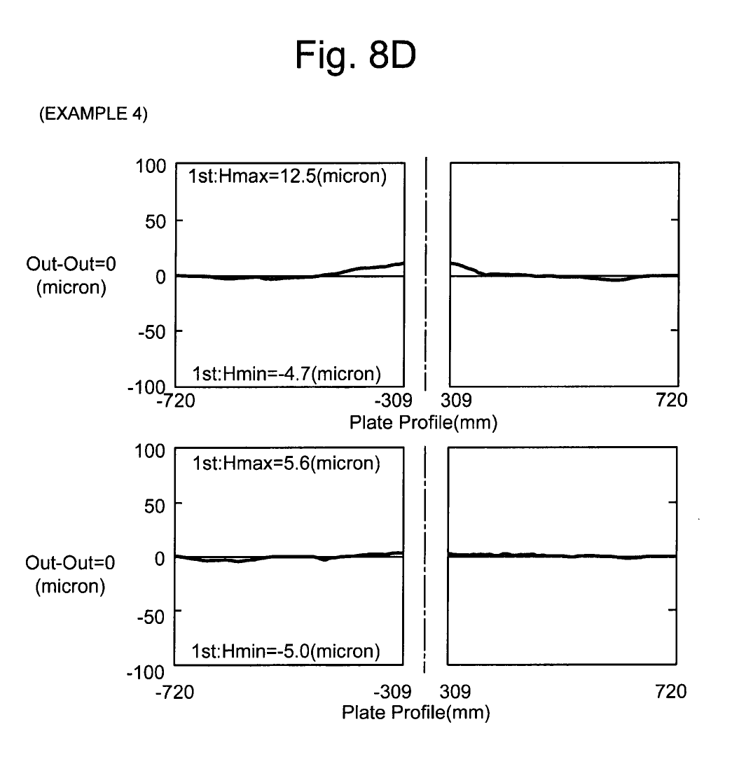

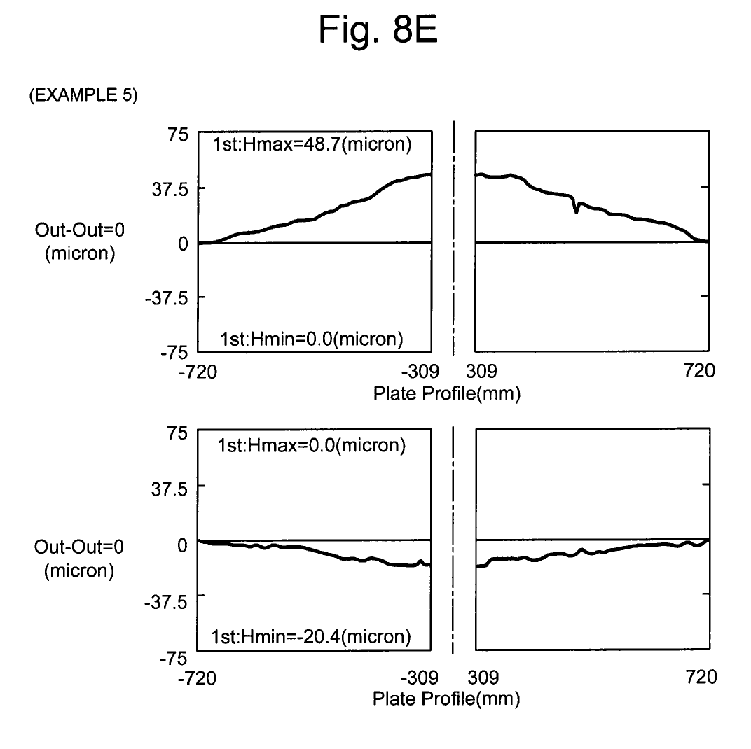

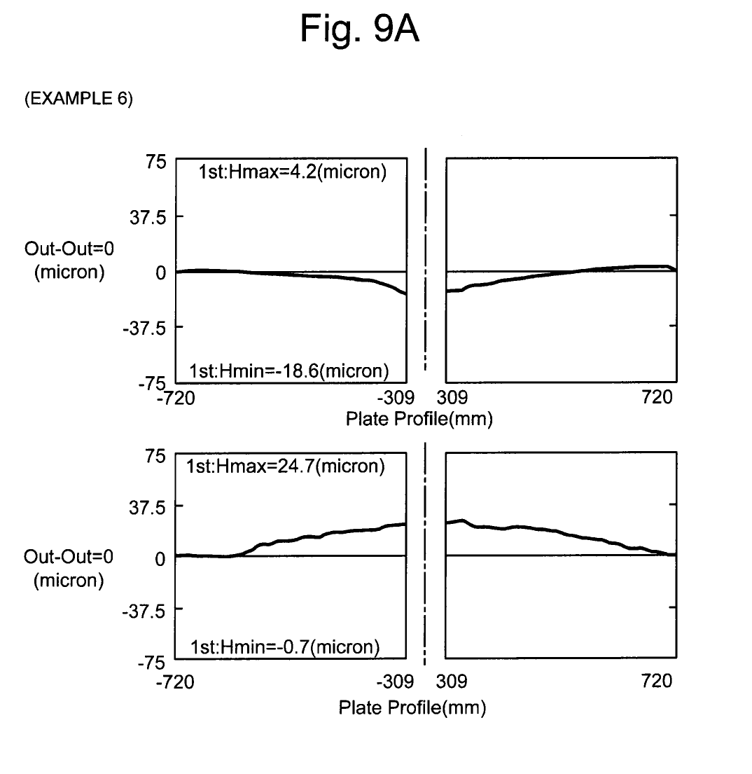

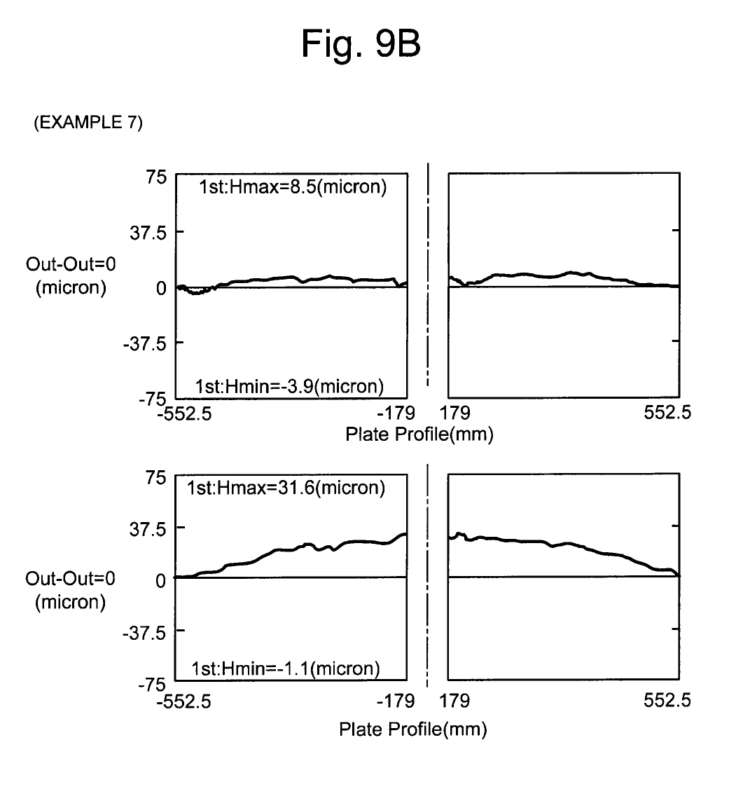

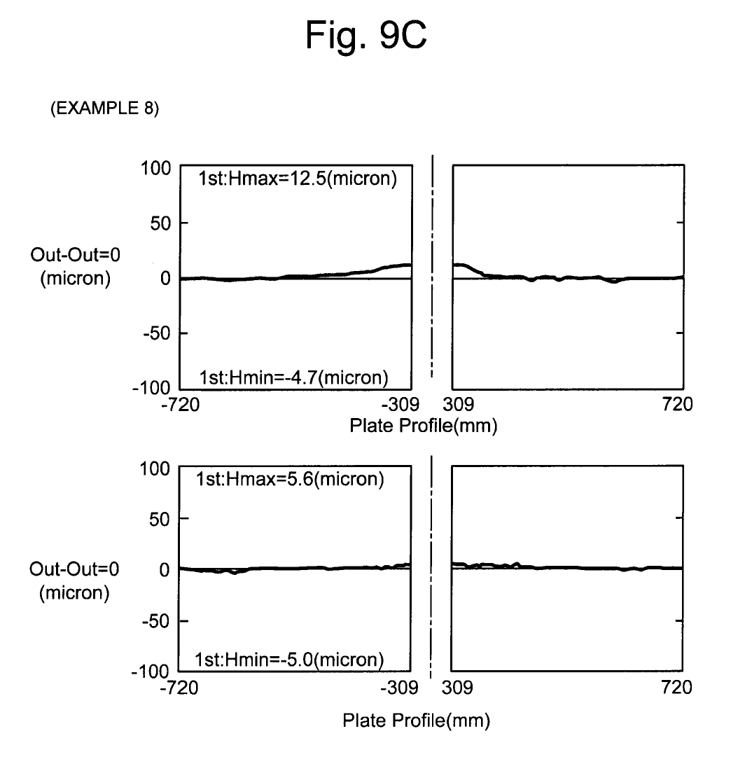

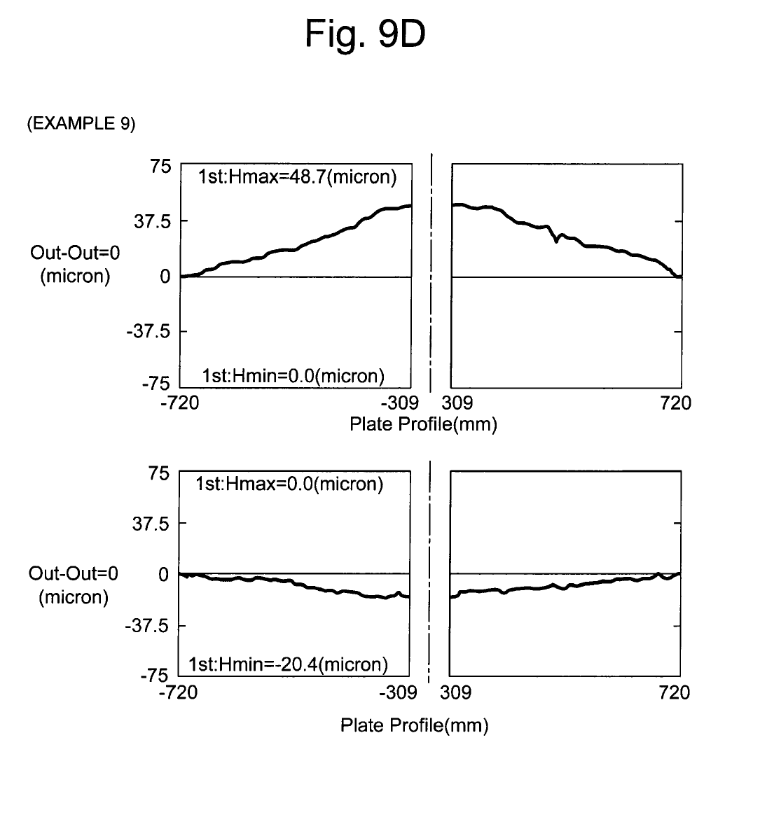

The measurement results of the shapes of the polishing surface 30 of the upper platen and the polishing surface 40 of the lower platen, measured using a straightness measuring device are shown in FIGS. 8A to 8E and 9A to 9D (Working Examples of the present invention). In FIGS. 8A to 8E and 9A to 9D, the profile on the upper stage is the measurement results of the shape of the polishing surface 30 of the upper platen, and the profile on the lower stage is the measurement results of the shape of the polishing surface 40 of the lower platen. The maximum height (Hmax) and the minimum height (Hmin) on the basis of the outer peripheral edges (X1 and X4) as a reference point are obtained from the shape measurement results of the polishing surfaces, and the maximum difference in height ΔH(=Hmax−Hmin) is calculated.

The shape measurement results of the polishing surface are further described below using Example 1 of FIG. 8A. In Example 1, the polishing surface 30 of the upper platen is that the maximum height (Hmax) is +49.2 μm and the minimum height (Hmin) is −0.1 μm. Therefore, the maximum difference in height ΔH1 (=Hmax−Hmin) of the polishing surface 30 of the upper platen is +49.3 μm. In Example 1, the polishing surface 40 of the lower platen is that the maximum height (Hmax) is +73.2 μm and the minimum height (Hmin) is −1.2 μm. Therefore, the maximum difference in height ΔH2(=Hmax−Hmin) of the polishing surface 40 of the lower platen is +74.4 μm. ΔD(=Dout−Din=ΔH2−ΔH1) is +25 μm, and the polishing surface of Example 1 of FIG. 8A is an inner contact state that the polishing surface 30 of the upper platen and the polishing surface 40 of the lower platen strongly contact to each other at the inner peripheral edge side (the shape shown in FIG. 6).

To obtain a glass substrate for a magnetic recording medium, having excellent parallelism by polishing the glass substrate using the double-sided polishing device 20, the shape ΔD(=Dout−Din) of the polishing surface 30 of the upper platen and the polishing surface 40 of the lower platen is from −30 μm to +30 μm.

When AD is less than −30 μm (for example, −40 μm), the polishing surface 30 of the upper platen and the polishing surface 40 of the lower platen strongly contact to each other at the outer peripheral edge side. As a result, polishing pressure to the glass substrate is increased at the outer peripheral edge side of the polishing surface. Furthermore, the peripheral speed of the glass substrate to be polished is high at the outer peripheral edge side of the polishing surface than the inner peripheral edge side thereof. Due to this, a removal volume of the glass substrate to be polished is increased when passing the outer peripheral edge side of the polishing surface. As a result, a removal volume on the same glass substrate surface and a removal volume among glass substrates polished in the same lot have variations, and it is difficult to obtain a glass substrate for a magnetic recording medium, having excellent parallelism.

When ΔD exceeds +30 μm, the polishing surface 30 of the upper platen and the polishing surface 40 of the lower platen contact too strongly to each other at the inner peripheral edge side. This makes difficult to stably rotation-drive the upper platen 201 and the lower platen 202, and polishing pressure cannot uniformly be applied to the glass substrate. As a result, a removal volume of the glass substrate varies and it is difficult to obtain a glass substrate for a magnetic recording medium, having excellent parallelism.

ΔD(=Dout−Din) is preferably from −25 μm to +25 μm, and further preferably from −23 μm to +23 μm, and particularly preferably from −10 μm to +20 μm.

The dressing treatment is conducted by supplying dressing liquid between the dressing jig and the polishing surfaces 30 and 40, relatively moving the dressing jig and the polishing surfaces 30 and 40, and lapping the polishing surfaces 30 and 40. The shapes of the polishing surface 30 of the upper platen and the polishing surface 40 of the lower platen can be formed in a given shape by controlling temperature difference ΔTpd (Tp−Td) between Td that is a temperature of the dressing liquid and Tp that is a temperature of the upper platen 201. Unless otherwise indicated, the upper platen 201 and the lower platen 202 are controlled to the same temperature.

When the Td that is a temperature of the dressing liquid is lower than the Tp that is a temperature of the upper platen 201, the upper platen 201 shrinks at the polishing surface side of the upper platen, and the lower platen 202 shrinks at the polishing surface side of the lower platen. Therefore, the shapes of the polishing surface 30 of the upper platen and the polishing surface 40 of the lower platen when conducting the dressing treatment are the polishing surface shape in an outer contact state (the shape shown in FIG. 7) that the polishing surface 30 of the upper platen and the polishing surface 40 of the lower platen strongly contact to each other at the outer peripheral edge side. When the dressing treatment is conducted in the outer contact state of the polishing surfaces, the outer peripheral edge side of the polishing surface is largely lapped. Therefore, after performing the dressing treatment, the shapes of the polishing surface 30 of the upper platen and the polishing surface 40 of the lower platen are formed into a polishing surface shape in an inner contact state (the shape shown in FIG. 6) that the polishing surface 30 of the upper platen and the polishing surface 40 of the lower platen strongly contact to each other at the inner peripheral edge side.

When the Td that is a temperature of the dressing liquid is higher than the Tp that is a temperature of the upper platen 201, the upper platen 201 expands at the polishing surface side of the upper platen, and the lower platen 202 expands at the polishing surface side of the lower platen. Therefore, the shapes of the polishing surface 30 of the upper platen and the polishing surface 40 of the lower platen when conducting the dressing treatment are the polishing surface shape in an inner contact state (the shape shown in FIG. 6) that the polishing surface 30 of the upper platen and the polishing surface 40 of the lower platen strongly contact to each other at the inner peripheral edge side. When the dressing treatment is conducted in the inner contact state of the polishing surfaces, the inner peripheral edge side of the polishing surfaces is largely lapped. Therefore, after performing the dressing treatment, the shapes of the polishing surface 30 of the upper platen and the polishing surface 40 of the lower platen are formed into a polishing surface shape in an outer contact state (the shape shown in FIG. 7) that the polishing surface 30 of the upper platen and the polishing surface 40 of the lower platen strongly contact to each other at the outer peripheral edge side.

To form the shape ΔD (=Dout−Din) of the polishing surface 30 of the upper platen and the polishing surface 40 of the lower platen to be from −30 μm to +30 μm, ΔTpd (=Tp−Td) is preferably −3° C. to +5° C.

When the dressing treatment is conducted at ΔTpd (=Tp−Td) of less than −3° C. (for example, −6° C.,), the shapes of the polishing surface 30 of the upper platen and the polishing surface 40 of the lower platen may become a polishing surface shape that ΔD (=Dout−Din) exceeds +30 μm. As a result, the polishing surface 30 of the upper platen and the polishing surface 40 of the lower platen contact too strongly to each other at the inner peripheral edge side. This makes difficult to stably rotation-drive the upper platen 201 and the lower platen 202, and polishing pressure cannot uniformly be applied to the glass substrate. As a result, a removal volume of the glass substrate varies and it may be difficult to obtain a glass substrate for a magnetic recording medium, having excellent parallelism.

When the dressing treatment is conducted in the state that ΔTpd (=Tp−Td) exceeds +5° C., the shapes of the polishing surface 30 of the upper platen and the polishing surface 40 of the lower platen become a polishing surface shape that ΔD (=Dout−Din) is less −30 μm. As a result, since the polishing surface 30 of the upper platen and the polishing surface 40 of the lower platen contact too strongly to each other at the outer peripheral edge side, polishing pressure to the glass substrate is increased at the outer peripheral edge side and peripheral speed of the glass substrate being polished becomes fast at the outer peripheral edge side as compared with the inner peripheral edge side. For those reasons, a removal volume is increased when the glass substrate for a magnetic recording medium to be polished passes the outer peripheral edge side. As a result, a removal volume in the same glass substrate surface and a removal volume among the glass substrate polished in the same lot vary, and it may be difficult to obtain a glass substrate for a magnetic recording medium, having excellent parallelism.

The temperature difference ΔTpd (=Tp−Td) between the Td that is a temperature of the dressing liquid and the Tp that is a temperature of the upper platen 201 is preferably from −3° C. to +5° C., and particularly preferably from −2° C. to +4° C.

The shapes of the polishing surface 30 of the upper platen and the polishing surface 40 of the lower platen are formed into the respective given shapes by the dressing treatment, and the polishing of the glass substrate is then conducted.

The glass substrate 10 for a magnetic recording medium is sandwiched between the polishing surface 30 of the upper platen and the polishing surface 40 of the lower platen in the state that the glass substrate is held on a glass substrate holding part of the carrier 50, and a polishing slurry is supplied to both main surfaces of the glass substrate in the state that the polishing surface 30 of the upper platen and the polishing surface 40 of the lower platen are pressed to the both main surfaces of the glass substrate, respectively. At the same time, the glass substrate and the polishing surfaces are relatively moved to simultaneously polish the both main surfaces of the glass substrate.

The shapes of the polishing surface 30 of the upper platen and the polishing surface 40 of the lower platen when the glass substrate is polished can be controlled by adjusting a temperature difference ΔTsp (=Ts−Tp) between Ts that is a temperature of the polishing slurry supplied to the both main surfaces of the glass substrate and the Tp that is a temperature of the upper platen 201.

When the Ts that is a temperature of the polishing slurry is lower than the Tp that is a temperature of the upper platen 201, the upper platen 201 shrinks at the polishing surface side of the upper platen, and the lower platen 202 shrinks at the polishing surface side of the lower platen. Therefore, the shapes of the polishing surface 30 of the upper platen and the polishing surface 40 of the lower platen during polishing the glass substrate is the polishing surface shape in an outer contact state (the shape shown in FIG. 7) that the polishing surface 30 of the upper platen and the polishing surface 40 of the lower platen strongly contact to each other at the outer peripheral edge side.

When the Ts that is a temperature of the polishing slurry is higher than the Tp that is a temperature of the upper platen 201, the upper platen 201 expands at the polishing surface side of the upper platen, and the lower platen 202 expands at the polishing surface side of the lower platen. Therefore, the shapes of the polishing surface 30 of the upper platen and the polishing surface 40 of the lower platen when the glass substrate is polished become the polishing surface shape in an inner contact state (the shape shown in FIG. 6) that the polishing surface 30 of the upper platen and the polishing surface 40 of the lower platen strongly contact to each other at the inner peripheral edge side.

The temperature difference ΔTsp (=Ts−Tp) between the Ts that is a temperature of the polishing slurry supplied to the both main surfaces of the glass substrate and the Tp that is a temperature of the upper platen 201 is preferably from −6° C. to +10° C.

When the glass substrate is polished at ΔTsp (=Ts−Tp) of less than −6° C. (for example, −10° C.), the polishing surface 30 of the upper platen and the polishing surface 40 of the lower platen contact too strongly to each other at the outer peripheral edge side. As a result, a removal volume of the substrate glass substrate is increased at the outer peripheral edge side of the polishing surface, and a removal volume in the same glass substrate surface and a removal volume among the glass substrates polished in the same lot vary, and it may be difficult to obtain a glass substrate for a magnetic recording medium, having excellent parallelism.

When the glass substrate is polished in the state that ΔTsp (=Ts−Tp) exceeds +10° C., the polishing surface 30 of the upper platen and the polishing surface 40 of the lower platen contact too strongly to each other at the inner peripheral edge side. This makes difficult to stably rotation-drive the upper platen 201 and the lower platen 202, and polishing pressure cannot uniformly be applied to the glass substrate. As a result, a removal volume of the glass substrate varies and it may be difficult to obtain a glass substrate for a magnetic recording medium, having excellent parallelism.

The temperature difference ΔTsp (=Ts−Tp) between the Ts that is a temperature of the polishing slurry supplied to the both main surfaces of the glass substrate and the Tp that is a temperature of the upper platen 201 is preferably from −6° C. to +10° C., further preferably from −6° C. to +8° C., and particularly preferably from −5° C. to +7° C.

The Td that is a temperature of the dressing liquid used in the dressing treatment which forms the shapes of the polishing surface 30 of the upper platen and the polishing surface 40 of the lower platen into a given shape affects the shape of the polishing surface before polishing the glass substrate, and the Ts that is a temperature of the polishing slurry used in polishing the glass substrate affects the shape of the glass substrate during the polishing the glass substrate. For this reason, the glass substrate is preferably polished while the temperature difference Tsd (=Ts−Td) between the Td that is a temperature of the dressing liquid and the Ts that is a temperature of the polishing slurry is adjusted to a given temperature range. The temperature difference ΔTsd (=Ts−Td) between the Td that is a temperature of the dressing liquid and the Ts that is a temperature of the polishing slurry is preferably from −6° C. to +10° C.

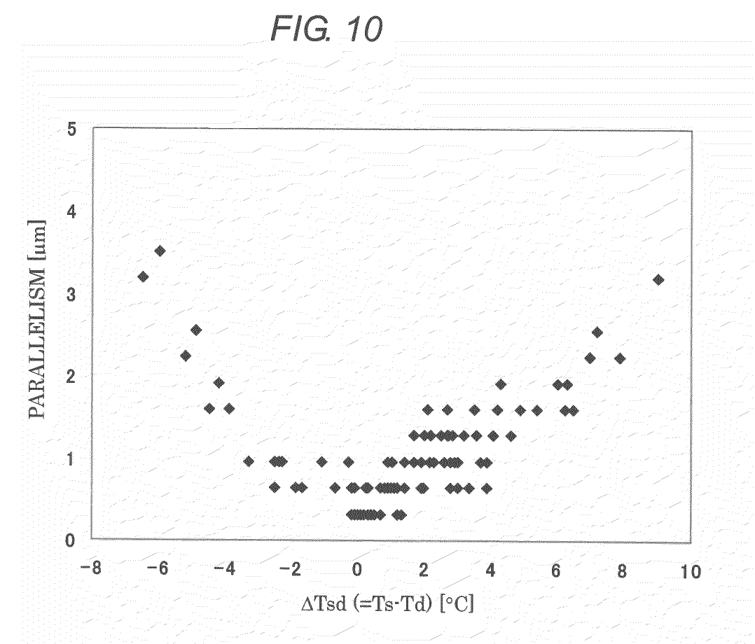

Results of the examination of the relationship between the temperature difference ΔTsd between the Td that is a temperature of the dressing liquid and the Ts that is a temperature of the polishing slurry, and the parallelism of the glass substrate polished are shown in FIG. 10 (Examples). When ΔTsd (=Ts−Td) is less than −6° C., it may be difficult to obtain the glass substrate for a magnetic recording medium, having excellent parallelism. On the other hand, when ΔTsd (=Ts−Td) exceeds +10° C., it may be difficult to obtain the glass substrate for a magnetic recording medium, having excellent parallelism. ΔTsd (=Ts−Td) is preferably from −6° C. to +10° C., further preferably from −6° C. to +8° C., and particularly from −5° C. to +7° C.

The glass substrate for a magnetic recording medium, having excellent parallelism such that the parallelism of both main surfaces of the substrate for a magnetic recording medium is 3.2 μm or less can be manufactured in high productivity by the method for manufacturing a glass substrate for a magnetic recording medium, including the polishing step of the present invention. The parallelism of both main surfaces of the glass substrate for a magnetic recording medium is 3.2 μm or less, preferably 3.0 μm or less, further preferably 2.8 μm or less, and particularly preferably 2.5 μm or less.

Furthermore, the glass substrate for a magnetic recording medium in which variation in parallelism among the glass substrates for a magnetic recording medium polished in the same lot is 1.5 μm or less can be manufactured in high productivity by the method for manufacturing a glass substrate for a magnetic recording medium, including the polishing step of the present invention. The variation in parallelism of both main surfaces among the glass substrates for a magnetic recording medium polished in the same lot is 1.5 μm or less, preferably 1.2 μm or less, further preferably 1.0 μm or less, and particularly preferably 0.8 μm or less.

### EXAMPLES

The present invention is further described below by reference to the following Examples and Comparative Examples, but it should be understood that the invention is not construed as being limited thereto.

### Preparation of Glass Substrate for Magnetic Recording Medium

A glass substrate comprising SiO₂ as a main component and being molded by a float process was processed into a doughnut-shaped circular glass substrate (disk-shaped glass substrate having a circular hole at the center thereof) for the purpose of obtaining a glass substrate for a magnetic recording medium having an outer diameter of 65 mm, an inner diameter of 20 mm and a thickness of 0.635 mm.

The inner peripheral side surface and the outer peripheral side surface of the doughnut-shaped circular glass substrate were subjected to chamfering so as to obtain a glass substrate for a magnetic recording medium having a chamfering width of 0.15 mm and a chamfering angle of 45°. The upper and lower main surfaces of the glass substrate were subjected to lapping with alumina abrasives, and the abrasives were removed by cleaning.

The inner peripheral side surface and the inner peripheral chamfered part were polished with a polishing brush and cerium oxide abrasives to remove scratches on the inner peripheral side surface and the inner peripheral chamfered part, and the inner peripheral edge was polished so as to obtain mirror surface. The glass substrate after polishing the inner peripheral edge was subjected to scrub cleaning with an alkaline detergent and ultrasonic cleaning in the state of dipping the glass substrate in the alkaline detergent, thereby removing the abrasives.

The outer peripheral side surface and the outer peripheral chamfered part of the glass substrate after polishing the inner peripheral edge were polished with a polishing brush and cerium oxide abrasives to remove scratches on the outer peripheral side surface and the outer peripheral chamfered part, and the outer peripheral edge was polished so as to obtain mirror surface. The glass substrate after polishing the outer peripheral edge was subjected to scrub cleaning with an alkaline detergent and ultrasonic cleaning in the state of dipping the glass substrate in the alkaline detergent, thereby removing the abrasives.

### Primary to Tertiary Polishings of Glass Substrate for Magnetic Recording Medium

Upper and lower main surfaces of the glass substrate after the edge processing were subjected to primary polishing with 22B double side polishing machine (product name: DSM22B-6PV-4 MH, manufactured by Speedfam Co., Ltd.) or 16B double side polishing machine (product name: 16BF-4M5P, manufactured by Hamai Co., Ltd.) using a hard urethane polishing pad as a polishing tool and a polishing slurry containing cerium oxide abrasives (polishing slurry composition comprising cerium oxide having an average particle diameter (hereinafter referred to as an “average particle size”) of about 1.3 μm) as a main component. Main polishing pressure was 85 g/cm², and rotation number of a platen was 30 rpm (Type 22B) and 45 rpm (Type 16B). The polishing was conducted by setting a polishing time such that the removal volume is 40 μm in total in the upper and lower main surfaces. Cerium oxide was removed by cleaning from the glass substrate after polishing, and the parallelism of the glass substrate was then measured.

In the primary polishing step, the polishing pads attached to the upper platen and the lower platen of the double side polishing machine were subjected to dressing treatment with a dressing jig comprising pellets containing diamond abrasives before polishing the glass substrate, thereby forming the surface of the polishing pads into a given polishing surface. The shape of the polishing surface of the polishing pad after the dressing treatment was measured with a straightness measuring device (product name: HSS-1700, manufactured by Hitz Hi-Technology Corporation).

The shapes of the polishing surface of the upper platen and the lower platen after the dressing treatment were measured by placing the straightness measuring device on the polishing surface (along line X shown in FIG. 5) and scanning such that a gauge head of the straightness measuring device passes the outer peripheral edges (X1 and X4) and the inner peripheral edges (X2 and X3) of the polishing surface. The maximum difference in height ΔH1 on the polishing surface of the upper platen, the maximum difference in height ΔH2 on the polishing surface of the lower platen, and ΔD (=ΔH2−ΔH1=Dout−Din) were obtained from the results obtained by measuring the polishing surface of the polishing pad after the dressing treatment.

The parallelism of the glass substrate polished was measured with a laser interferometer (product name: G102, manufactured by Fujinon Co., Ltd.). As shown in FIG. 3A, the parallelism was calculated by observing the number of interference fringes formed by retardation of reflected light from both main surfaces of the glass substrate, and multiplying 0.32 by the number of interference fringes observed. The parallelism was measured by setting a measurement region so as to include a recording and reproducing region of the glass substrate for a magnetic recording medium having an outer diameter of 65 mm and an inner diameter of 20 mm. In the present Examples, the measurement region was set to from 10.0 mm to 32.5 mm from the center of the disk, and the parallelism was measured on the region. When the glass substrate was polished with the 22B double side polishing machine, six glass substrates were extracted from one lot (180 glass substrates), and the parallelism was measured on the extracted glass substrates. When the glass substrate was polished with the 16B double side polishing machine, five glass substrates were extracted from one lot (100 glass substrates), and the parallelism was measured on the extracted glass substrates.

Measurement results of the parallelism of glass substrates polished by the double side polishing machine having the shape (ΔH, ΔH2 and ΔD) of each polishing surface are shown in Examples 1 to 5 of Table 1. Example 2 is the result of polishing the glass substrate with the 16B double side polishing machine, Examples 1, 3, 4 and 5 are the results of polishing the glass substrate with the 22B double side polishing machine. In Table 1, Examples 1 to 4 are Working Examples, and Example 5 is Comparative Example. Shape measurement results (profile of straightness measuring device) of the polishing surface of the upper platen and the polishing surface of the lower platen, before polishing the glass substrate are shown in Examples 1 to 5 of FIGS. 8A to E.

In Examples 1 to 4 in which AD showing the shape of the polishing surface of the double side polishing machine is from −30 μm to +30 μm, the parallelism of the glass substrate was 3.2 μm or less, and variation (difference between the maximum parallelism value and the minimum parallelism value) in the parallelism among the glass substrates polished in the same lot was 1.5 μm or less.

The shapes (ΔH, ΔH2 and ΔD) of the polishing surfaces formed when the dressing treatment was conducted at the Tp that is a temperature of each upper platen and the Td that is a temperature of the dressing liquid are shown in Examples 6 to 9 of Table 3. Example 7 is the result regarding the 16B double side polishing machine, and Examples 6, 8 and 9 are the results regarding the 22B double side polishing machine. In Table 3, Examples 7 and 8 are Working Examples, and Examples 6 and 9 are Comparative Examples. In the present Examples, the Td that is a temperature of the dressing liquid is a temperature of dressing liquid before the dressing liquid is fed to the double side polishing machine.

In Examples 7 and 8 in which ΔTpd (=Tp−Td) is from −3° C. to +5° C., the shape ΔD of the polishing surface after the dressing treatment is formed to be from −30 μm to +30 μm.

The parallelism of the glass substrate when the difference ΔTsd (=Ts−Td) between the Ts that is a temperature of the polishing slurry and the Td that is a temperature of the dressing liquid was set to each temperature difference and the glass substrate was polished is shown in FIG. 10. In the present Examples, the Ts that is a temperature of the polishing slurry is a temperature of a polishing slurry before supplying to the double side polishing machine. The parallelism of the glass substrate polished by setting the Ts that is a temperature of the polishing slurry such that ΔTsd becomes from −6° C. to +10° C. was 3.2 μm or less.

The upper and lower main surfaces of the glass substrate after the primary polishing were polished with a double side polishing machine using a soft urethane polishing pad as a polishing tool and a polishing slurry containing cerium oxide abrasives having an average particle size smaller than that of the cerium oxide abrasives used in the primary polishing (polishing slurry composition comprising cerium oxide having an average particle size of about 0.5 μm as a main component), and the cerium oxide was removed by cleaning.

The glass substrate after a secondary polishing as above was subjected to finish polishing (tertiary polishing). The upper and lower main surfaces of the glass substrate were polished with a double side polishing machine using a soft urethane polishing pad as a polishing tool of the finish polishing (tertiary polishing) and a polishing slurry containing colloidal silica (polishing slurry composition comprising colloidal silica having an average particle size of primary particles of from 20 to 30 nm as a main component).

The glass substrate after the tertiary polishing was dipped in a solution having pH adjusted to the same pH of the polishing slurry for the finish polishing, and successively subjected to scrub cleaning with an alkaline detergent, ultrasonic cleaning in the state that the glass substrate was dipped in the alkaline detergent solution, and ultrasonic cleaning in the state that the glass substrate was dipped in pure water. The glass substrate was then dried with vapor of isopropyl alcohol.

After cleaning and drying the glass substrate, the parallelism of the glass substrate for a magnetic recording medium was measured. The parallelism of the glass substrate for a magnetic recording medium was measured in the same manner as in the glass substrate after the primary polishing. Glass substrates for a magnetic recording medium obtained by subjecting the glass substrates polished with the double side polishing machine having the shapes of the polishing surface of Examples 1 to 4 to secondary polishing and tertiary polishing had the parallelism of 1.5 μm or less. The variation in parallelism (difference between maximum parallelism value and minimum parallelism value) among the glass substrates polished in the same lot was 1.0 μm or less. Furthermore, glass substrates for a magnetic recording medium obtained by subjecting glass substrates polished by setting the Ts that is a temperature of the polishing slurry such that ΔTsd becomes from −6° C. to +10° C. as shown in FIG. 10, to secondary polishing and tertiary polishing had the parallelism of 1.5 μm or less. The variation in parallelism (difference between maximum parallelism value and minimum parallelism value) among the glass substrates polished in the same lot was 1.0 μm or less.

Nano waviness Wq of the glass substrate for a magnetic recording medium after measuring the parallelism was measured with a light scattering surface profiler (product name: Candela 6100, manufactured by KLA Tencor). Measurement region of the nano waviness Wq was set in an outer diameter side region (position of from 30.5 mm to 31.5 mm from the center of the disk) on the main surface of the glass substrate for a magnetic recording medium, and the nano waviness Wq was measured on the region. The correlation graph obtained by plotting the parallelism of the glass substrate for a magnetic recording medium and the nano waviness Wq on the outer diameter side region is shown in FIG. 11. When the parallelism exceeds 3.5 μm, the nano waviness Wq on the outer diameter side region exceeds 0.52 nm.

HDD test results of magnetic disks manufactured by forming a thin film such as a magnetic layer on glass substrates for a magnetic recording medium are shown in Table 1. When the nano waviness Wq on the outer diameter side region exceeds 0.52 nm, floating posture of a magnetic head is disturbed, and the magnetic head contacts the magnetic recording medium, thereby generating a fault of HDD. It is seen from the correlation graph between the parallelism of the glass substrate for a magnetic recording medium and the nano waviness Wq on the outer diameter side region that the parallelism of the glass substrate for a magnetic recording medium that does not generate a fault of a magnetic head in the HDD test is 3.2 μm or less.

TABLE 1

| | Nano waviness Wq on outer | |
|---|---|---|
| No. | diameter side region (nm) | HDD test result |
| 1 | 0.28 | OK |
| 2 | 0.30 | OK |
| 3 | 0.31 | OK |
| 4 | 0.32 | OK |
| 5 | 0.33 | OK |
| 6 | 0.34 | OK |
| 7 | 0.36 | OK |
| 8 | 0.37 | OK |
| 9 | 0.39 | OK |
| 10 | 0.46 | OK |
| 11 | 0.49 | OK |
| 12 | 0.52 | OK |
| 13 | 0.52 | NG |
| 14 | 0.53 | NG |
| 15 | 0.58 | NG |
| 16 | 0.70 | NG |
| 17 | 0.84 | NG |
| 18 | 1.03 | NG |

TABLE 2

| | Maximum difference | | | | | |
|---|---|---|---|---|---|---|
| | in height of polishing | | | | | |
| | surface (μm) | | | Parallelism of glass substrate | | |
| | Upper | Lower | Double side polishing machine | | Number of | |
| | platen | platen | Shape of polishing surface | | interference | Parallelism |
| No. | (ΔH1) | (ΔH2) | ΔD (μm) (=ΔH2 − H1) | Glass substrate No. | fringes | (μm) |
| Example 1 | 49 | 74 | 25 | 1 | 8 | 2.6 |
| | | | | 2 | 6 | 1.9 |
| | | | | 3 | 10 | 3.2 |
| | | | | 4 | 9 | 2.9 |
| | | | | 5 | 10 | 3.2 |
| | | | | 6 | 7 | 2.2 |
| | | | | In lot, average value | | 2.7 |
| | | | | In lot, variation value | | 1.3 |
| Example 2 | 12 | 33 | 20 | 1 | 2 | 0.6 |
| | | | | 2 | 1 | 0.3 |
| | | | | 3 | 3 | 1.0 |
| | | | | 4 | 2 | 0.6 |
| | | | | 5 | 3 | 1.0 |
| | | | | In lot, average value | | 0.7 |
| | | | | In lot, variation value | | 0.6 |
| Example 3 | 22 | 26 | 4 | 1 | 2 | 0.6 |
| | | | | 2 | 1 | 0.3 |
| | | | | 3 | 3 | 1.0 |
| | | | | 4 | 1 | 0.3 |
| | | | | 5 | 2 | 0.6 |
| | | | | 6 | 1 | 0.3 |
| | | | | In lot, average value | | 0.5 |
| | | | | In lot, variation value | | 0.6 |
| Example 4 | 17 | 11 | −6 | 1 | 3 | 1.0 |
| | | | | 2 | 2 | 0.6 |
| | | | | 3 | 1 | 0.3 |
| | | | | 4 | 1 | 0.3 |
| | | | | 5 | 2 | 0.6 |
| | | | | 6 | 2 | 0.6 |
| | | | | In lot, average value | | 0.6 |
| | | | | In lot, variation value | | 0.6 |
| Example 5 | 49 | −20 | −69 | 1 | 20 | 6.4 |
| | | | | 2 | 18 | 5.8 |
| | | | | 3 | 21 | 6.7 |
| | | | | 4 | 15 | 4.8 |
| | | | | 5 | 17 | 5.4 |
| | | | | 6 | 19 | 6.1 |
| | | | | In lot, average value | | 5.9 |
| | | | | In lot, variation value | | 1.9 |

TABLE 3

| | | | | Maximum difference in | | |
|---|---|---|---|---|---|---|
| | | | | height of polishing surface | | |
| | Upper platen | Dressing liquid | | (μm) | | Double side polishing machine |
| | temperature | temperature | ΔTpd (° C.) | Upper platen | Lower platen | Shape of polishing surface |
| No. | Tp (° C.) | Td (° C.) | (=Tp − Td) | (ΔH1) | (ΔH2) | ΔD (μm) (=ΔH2 − H1) |
| Example 6 | 24 | 18 | 6 | −23 | 25 | 48 |
| Example 7 | 24 | 20 | 4 | 12 | 33 | 20 |
| Example 8 | 24 | 25 | −1 | 17 | 11 | −7 |
| Example 9 | 24 | 31 | −7 | 49 | −20 | −69 |

While the invention has been described in detail with reference to specific embodiments thereof, it will be apparent to one skilled in the art that various changes and modifications can be made therein without departing from the spirit and scope thereof.

Incidentally, the present application is based on Japanese Patent Applications No. 2010-020520 filed on Feb. 1, 2010, and the contents are incorporated herein by reference.

Also, all the references cited herein are incorporated as a whole.

The present invention can be applied to a method for manufacturing a glass substrate, including a step of polishing a glass substrate having a sheet shape. As the glass substrate having a sheet shape, glass substrates for a magnetic recording medium, for a photomask, and for a display such as liquid crystal or organic EL may be specifically mentioned.

### DESCRIPTION OF REFERENCE NUMERALS AND SIGNS

10: Glass substrate for magnetic recording medium
101: Main surface of glass substrate for magnetic recording medium
102: Inner peripheral side surface
103: Outer peripheral side surface
104: Inner peripheral chamfered part
105: Outer peripheral chamfered part
A1, A6: Thickness in outer diameter side region of glass substrate for magnetic recording medium
A2, A5: Thickness in intermediate region of glass substrate for magnetic recording medium
A3, A4: Thickness in inner diameter side region of glass substrate for magnetic recording medium
20: Double side polishing machine
30: Polishing surface of upper platen
40: Polishing surface of lower platen
50: Carrier
201: Upper platen
202: Lower platen
203: Sun gear
204: Internal gear
X: Shape measurement position of polishing surface
X2, X3: Inner peripheral edges of polishing surfaces 30, 40
X1, X4: Outer peripheral edges of polishing surfaces 30, 40
Din: Distance between polishing surface 30 of upper platen and polishing surface 40 of lower platen, at inner peripheral edge
Dout: Distance between polishing surface 30 of upper platen and polishing surface 40 of lower platen, at outer peripheral edge
ΔH1: Maximum difference in height of polishing surface 30 of upper platen
ΔH2: Maximum difference in height of polishing surface 40 of lower platen

What is claimed is:

1. A glass substrate for a magnetic recording medium, which is a disk-shaped glass substrate for a magnetic recording medium having a circular hole at the center thereof,
wherein the glass substrate for a magnetic recording medium has an inner peripheral side surface, an outer peripheral side surface and both main surfaces, and
the both main surfaces have parallelism of 3.2 μm or less in at least a recording and reproducing region thereof.

2. A method for manufacturing a glass substrate for a magnetic recording medium, said method comprising a shape-forming step of performing shape forming to a glass substrate having a sheet shape; a lapping step of lapping a main surface of the glass substrate; a polishing step of polishing said main surface; and a cleaning step of cleaning the glass substrate,
wherein the polishing step comprises:
interposing a carrier holding the glass substrate having a sheet shape between a polishing surface of an upper platen of a double side polishing machine and a polishing surface of a lower platen thereof; and
polishing both main surfaces of the glass substrate simultaneously by relatively moving the glass substrate and the polishing surfaces, while supplying a polishing slurry to the both main surfaces of the glass substrate in the state that the polishing surface of the upper platen and the polishing surface of the lower platen are pressed to the both main surfaces of the glass substrate, respectively,
the upper platen and the lower platen have a disk shape having an inner peripheral edge and an outer peripheral edge, and
shapes of the polishing surface of the upper platen and the polishing surface of the lower platen, of the double side polishing machine before polishing the glass substrate are shapes so that when a distance between the polishing surface of the upper platen and the polishing surface of the lower platen, at the inner peripheral edge is Din and a distance between the polishing surface of the upper platen and the polishing surface of the lower platen, at the outer peripheral edge is Dout, ΔD (=Dout−Din) obtained by subtracting Din from Dout is from −30 μm to +30 μm.

3. The method for manufacturing a glass substrate for a magnetic recording medium according to claim 2, wherein the polishing step comprises a dressing treatment step of forming shapes of the polishing surface of the upper platen and the polishing surface of the lower platen, and a dressing liquid used in the dressing treatment step has Td that is a temperature in which ΔTpd (=Tp−Td) obtained by subtracting Td from Tp that is a temperature of the upper platen is from −3° C. to +5° C.

4. The method for manufacturing a glass substrate for a magnetic recording medium according to claim 2, wherein in the polishing step, the polishing slurry has Ts that is a temperature in which ΔTsp (=Ts−Tp) obtained by subtracting Tp that is a temperature of the upper platen from Ts is from −6° C. to +10° C.

5. The method for manufacturing a glass substrate for a magnetic recording medium according to claim 2, wherein in the polishing step, Ts that is a temperature of the polishing slurry is a temperature in which ΔTsd (=Ts−Td) obtained by subtracting Td that is a temperature of the dressing liquid used in the dressing treatment from Ts is from −6° C. to +10° C.

6. A glass substrate for a magnetic recording medium manufactured by the method for manufacturing a glass substrate for a magnetic recording medium according to claim 2, wherein the both main surfaces have parallelism of 3.2 μm or less in at least a recording and reproducing region thereof.

7. A glass substrate for a magnetic recording medium manufactured by the method for manufacturing a glass substrate for a magnetic recording medium according to claim 2, wherein variation in parallelism among glass substrates for a magnetic recording medium polished in the same lot is 1.5 μm or less.
